(19) United States
(12) Patent Application Publication
(10) Pub. No.: US 2026/0135023 A1
(43) Pub. Date: May 14, 2026

(54) HIGH-COERCIVITY AND HIGH-REMANENCE NdFeB MAGNET AND PREPARATION METHOD

(71) Applicants: BEIJING ZHONG KE SAN HUAN HI-TECH CO., LTD., Beijing (CN); TIANJIN SANHUAN LUCKY NEW MATERIAL CO.,LTD., Tianjin (CN)

(72) Inventors: Zhixue LI, Tianjin (CN); Shaofang LI, Tianjin (CN); Yi CHENG, Tianjin (CN); Lijun CAO, Tianjin (CN); Fei DU, Beijing (CN); Zhan WANG, Beijing (CN)

(21) Appl. No.: 19/338,664

(22) Filed: Sep. 24, 2025

(30) Foreign Application Priority Data
Nov. 13, 2024 (CN) 202411622137.0

(51) Int. Cl. H01F 1/057; B22F 3/12; C22C 38/00; C22C 38/10; C22C 38/14; C22C 38/16; H01F 41/02

(52) U.S. Cl. CPC H01F 1/0577; B22F 3/12; C22C 38/002; C22C 38/005; C22C 38/10; C22C 38/14; C22C 38/16; H01F 1/0576; H01F 41/0266; H01F 41/0293; B22F 2301/355; B22F 2304/10

(57) ABSTRACT

A high-coercivity and high-remanence NdFeB magnet includes R, M, B, and Fe, R includes RL and RH, RL includes at least one of Pr, Nd, La, Ce, or Y, RH includes at least one of Dy, Tb, Gd, or Ho, M includes Co, Cu, and M′, and M′ includes at least one of Cr, Ni, Ga, Al, Zr, Nb, or Ti. The NdFeB magnet includes R₂ T₁₄B main phase grains and grain boundary phase A, R content in the grain boundary phase A is in a range of 29 at % to 55 at %, Co content in the grain boundary phase A is in a range of 3 at % to 7 at %, Cu content in the grain boundary phase A is in a range of 7 at % to 20 at %.

### CROSS-REFERENCE TO RELATED APPLICATION

This application claims priority to Chinese Application No. 202411622137.0, filed on Nov. 13, 2024, the entire content of which is incorporated herein by reference.

### TECHNICAL FIELD

The present disclosure relates to magnet, in particular, to a high-coercivity and high-remanence NdFeB magnet and a preparation method thereof.

### BACKGROUND

Sintered NdFeB magnets, owing to their superior magnetic properties, are widely applied in various fields such as the automotive industry, medical equipment, information and electronics, and aerospace. In recent years, with the continuous improvement in the performance of sintered NdFeB magnets, their application domains have been expanding. The requirements for magnetic body performance (such as magnetic properties and high-temperature stability) are also increasing. A common method for preparing high-coercivity NdFeB magnets is by incorporating heavy rare earth elements like Dy, Tb, Ho through grain boundary diffusion. This involves placing heavy rare earth elements on the surface of the magnet with a concentration difference between the surface and interior of the heavy rare earth elements serving as the diffusion driving force. Magnets prepared through grain boundary diffusion exhibit excellent comprehensive magnetic properties with minimal consumption of heavy rare earths. However, currently produced magnets using grain boundary diffusion technology have a limited depth of heavy rare earth element diffusion. As the thickness of the magnet increases, it becomes more challenging to achieve diffusion into the interior of the magnet. This results in low efficiency in diffusion and consequently limits the enhancement of magnetic body coercivity. Consequently, this leads to poorer magnetic performance.

In terms of enhancing the high-temperature stability of magnets, current technologies often incorporate elements such as Co into NdFeB magnets. CN115346746A discloses a technique that employs a diffusion source containing Co along with other components like light rare earths and/or heavy rare earths for composite grain boundary diffusion treatment. The presence of light rare earths and/or heavy rare earths in the grain boundary phase hinders the further penetration of Co elements, leading to their minimal or almost non-existent entry into the grain boundary phase. This makes it difficult to effectively improve magnetic performance and temperature stability. To address this, the patent suggests applying M1-Co metal powders on the surface of the magnet to increase the content of Co elements in the grain boundary phase, thereby enhancing magnetic performance and temperature stability. However, due to the absence of heavy rare earth elements in the diffusion source, this results in a limited increase in magnetic coercivity. This makes it challenging to meet the demands for high-performance magnets.

### SUMMARY

Given the problems in existing technologies, the present disclosure provides a high-coercivity and high-remanence NdFeB magnet, along with its preparation method. The NdFeB magnet prepared by the method provided by the present disclosure has low content of impurity elements, effectively improved diffusion depth of heavy rare earth elements, little reduction in remanence, and high coercivity and high squareness.

To achieve the above object, the present disclosure adopts the following technical solutions:

A first aspect of the present disclosure provides an NdFeB magnet, where the NdFeB magnet includes R₂ T₁₄B main phase grains and grain boundary phase A.

The NdFeB magnet includes R, M, B, and Fe, where R includes RL and RH; RL includes at least one of Pr, Nd, La, Ce, or Y; RH includes at least one of Dy, Tb, Gd, or Ho; Fe is iron; B is boron; M includes Co, Cu, and M′, where M′ includes at least one of Cr, Ni, Ga, Al, Zr, Nb, or Ti.

In the grain boundary phase A, an R content is in a range of 29 at % to 55 at %, a Co content is in a range of 3 at % to 7 at %, an Cu content is in a range of 7 at % to 20 at %.

Optionally, the M includes Ga, the Ga content in the grain boundary phase A is in a range of 2 at % to 11 at %.

Optionally, an R content in the magnet is in a range of 28.5 wt % to 31 wt %, an M content in the magnet is in a range of 0.8 wt % to 3 wt %, a B content in the magnet is in a range of 0.94 wt % to 1.02 wt %, and the balance is iron and unavoidable impurities; and/or, a Co content in the magnet is in a range of 1 wt % to 1.5 wt %, a Cu content in the magnet is in a range of 0.15 wt % to 0.3 wt %, a Ga content in the magnet is in a range of 0.2 wt % to 0.4 wt %, a Ti and/or Zr content in the magnet is in a range of 0.05 wt % to 0.35 wt %.

Optionally, the NdFeB magnet satisfies one or more of the following conditions:
A. The impurities include at least one of C, N, or O; the content of impurity elements in the NdFeB magnet is less than 1500 ppm;
B. The content of N in the NdFeB magnet is less than 200 ppm.

Optionally, a particle size D50 of the main phase grains is in the range from 2.5 μm to 4 μm.

A second aspect of the present disclosure provides a method for preparing an NdFeB magnet, where the method comprises:
attaching a diffusion source to the surface of an NdFeB substrate to form a film layer;
performing a first diffusion treatment and a second diffusion treatment on the NdFeB substrate with the surface-attached film layer to obtain a diffusion-treated magnet; and
performing an aging treatment on the diffusion-treated magnet to obtain an NdFeB magnet;
where the NdFeB substrate includes R1, M1, B, or Fe, where R1 includes at least one of Dy, Tb, Pr, Nd, La, Ce, Y, Ho or Gd; M1 includes Co, Cu, and M′, where M′ includes at least one of Cr, Ni, Ga, Al, Zr, Nb, or Ti; in the NdFeB substrate, the content of R1 is in the range from 28.5 wt % to 31 wt %, the content of M1 is in the range from 0.6 wt % to 2.5 wt %, the content of B is in the range from 0.94 wt % to 1.02 wt %, the content of Co is in the range from 0.5 wt % to 2.5 wt %, and the balance is Fe and impurity elements, where the impurity elements include at least one of C, O, or N; the content of impurity elements in the NdFeB substrate is less than 1500 ppm, and the content of N is less than 200 ppm.

The diffusion source includes RH1, M2, and R2, where RH1 includes at least one of Dy, Tb, or Ho, R2 includes at least one of Pr and Nd, M2 includes Co and M2′, where M2′ includes at least one of Ga, Al, or Cu; in the diffusion source, the content of RH1 is in the range from 30 wt % to 70 wt %, the content of M2 is in the range from 5 wt % to 30 wt %, the content of R2 is in the range from 20 wt % to 50 wt %, and the content of Co is in the range from 1 wt % to 15 wt %.

The temperature of the second diffusion treatment is in the range from 840° C. to 880° C., and the holding time is in the range from 4 h to 20 h; the ratio of the temperature of the first diffusion treatment to the temperature of the second diffusion treatment is in the range from 1.01 to 1.08; the ratio of the holding time of the first diffusion treatment to the holding time of the second diffusion treatment is in the range from 0.1 to 0.3.

Optionally, the method satisfies one or more of the following conditions:

In the NdFeB substrate, the content of R1 is in the range from 29.5 wt % to 30.5 wt %, the content of M1 is in the range from 0.6 wt % to 1.5 wt %, the content of B is in the range from 0.96 wt % to 1.0 wt %, and the balance is Fe and impurity elements.

The content of Dy in the NdFeB substrate is in the range from 2 wt % to 4 wt %.

In the NdFeB substrate, the content of Co is in the range from 1 wt % to 1.5 wt %, the content of Cu is in the range from 0.1 wt % to 0.3 wt %, the content of Ga is in the range from 0.1 wt % to 0.5 wt %, and the content of Zr and/or Ti is in the range from 0.05 wt % to 0.35 wt %.

Optionally, the method satisfies one or more of the following conditions: repeating the first diffusion treatment and the second diffusion treatment to obtain the diffusion-treated magnet.

The total number of times that the first diffusion treatment and the second diffusion treatment are performed is in the range from 2 to 8.

Optionally, the method further comprises: sequentially performing molding process on NdFeB alloy powder and sintering treatment to obtain the NdFeB substrate.

The D50 particle size of the NdFEB alloy powder is in the range from 2 μm to 5 μm.

The molding process is an oriented pressing molding process, which is performed under an oriented magnetic induction intensity in the range from 1.8 T to 2.3 T.

The sintering treatment includes a first sintering treatment and a second sintering treatment; the temperature of the first sintering treatment is in the range from 750° C. to 980° C., and the sintering time is in the range from 8 h to 10 h; the temperature of the second sintering treatment is in the range from 1000° C. to 1080° C., and the sintering time is in the range from 8 h to 12 h; the vacuum degree of the sintering treatment is in the range from 10⁻⁵ Pa to 10⁻² Pa; the density of the NdFeB substrate obtained by the sintering treatment is in the range from 7.5 g/cm³ to 7.8 g/cm³.

Optionally, in the process of attaching a diffusion source to the surface of an NdFeB substrate, the weight gain of the NdFeB substrate with the surface-attached film layer is in the range from 0.5% to 1.5%.

In the diffusion source, the content of RH1 is in the range from 45 wt % to 65 wt %, the content of M2 is in the range from 10 wt % to 20 wt %, the content of R2 is in the range from 30 wt % to 40 wt %; the content of Co in the diffusion source is in the range from 5 wt % to 10 wt %.

Optionally, the method satisfies one or more of the following conditions: the temperature of aging treatment is in a range from 450° C. to 690° C., the holding time is range from 0.5h to 4h.

A third aspect of the present disclosure provides an NdFeB magnet prepared by the method described in the second aspect of the present disclosure.

Through the above technical solution, the present disclosure uses an NdFeB substrate with low content of impurity elements (C, N, O), which reduces the combination of R elements with impurity elements, effectively avoids the formation of secondary phases other than main phase grains, ensures that the substrate has unobstructed diffusion channels, and helps to improve the diffusion depth of heavy rare earth elements (e.g., Dy, Tb) in subsequent diffusion treatments. Meanwhile, the composition of the diffusion source is reasonably designed, and the contents of R2, Co, and M2 are controlled, so that the eutectic temperature of the R-Fe system is reduced, which can effectively promote diffusion, effectively increase the diffusion depth, and at the same time promote more Co elements to penetrate into the grain boundary phase; in addition, the addition of R2, especially Pr, can effectively reduce the eutectic point/melting point, which not only ensures that the light rare earth elements and low-melting-point elements contained in the diffusion source further optimize the grain boundary structure of the NdFeB substrate during diffusion, but also provides a concentration gradient for the diffusion of heavy rare earth elements, promotes the diffusion of heavy rare earth elements into the interior of the substrate, and increases the diffusion depth of heavy rare earths. The method of the present disclosure adopts a segmented diffusion process to perform diffusion treatment on the substrate, where the first diffusion treatment uses high-temperature and short-time heat treatment, which can form a uniform heavy rare earth shell layer on the surface of the main phase grains, effectively preventing more heavy rare earth elements from remaining on the surface of the main phase, and effectively promoting the diffusion of heavy rare earth elements and Co elements into the interior of the magnet; the second diffusion treatment uses low-temperature and long-time heat treatment, which can further promote the diffusion of heavy rare earth elements into the interior of the magnet, effectively control the diffusion rate, and further improve the uniformity of diffusion; in addition, the present disclosure repeats the above segmented diffusion process multiple times, aiming to further improve the diffusion of heavy rare earth elements into the center of the magnet and the uniformity of diffusion for the components of the substrate and diffusion source provided by the present disclosure, and can effectively control the size of main phase grains, thereby improving the coercivity of the magnet. The NdFeB magnet prepared by the method of the present disclosure can form a grain boundary phase A in the grain boundary phase, so that Co and Cu elements are enriched in the grain boundary phase, reducing the influence of the reverse shell layer on the diffusion depth of heavy rare earth elements during diffusion, and improving the magnetic performance; in addition, the grain boundary phase A is uniformly distributed along the grain boundaries, which can inhibit the abnormal growth of grains, prevent the degradation of magnetic performance of the NdFeB magnet due to abnormal grain growth, thereby effectively increasing the diffusion depth of heavy rare earth elements with good diffusion effect, and making the prepared NdFeB magnet have high coercivity, high remanence, and high squareness.

### BRIEF DESCRIPTION OF THE DRAWING

FIG. 1 is an SEM photograph of the NdFEB magnet in Embodiment 1.

FIG. 2 is an EPMA detection diagram of Dy element at 500 μm from the diffusion surface of the NdFeB magnet in Embodiment 1.

### DETAILED DESCRIPTION OF EMBODIMENTS

In this disclosure, wt % represents weight percentage and at % represents atomic percentage.

The specific embodiments of the present disclosure will be described in detail below. It should be understood that the specific embodiments described herein are only used to illustrate and explain the present disclosure, but not to limit the present disclosure.

A first aspect of the present disclosure provides an NdFeB magnet, where the NdFeB magnet includes R2 T₁₄B main phase grains and R-containing grain boundary phases, and the R-containing grain boundary phases include grain boundary phase A; the NdFeB magnet includes R, M, B, or Fe, where R includes RL and RH; RL includes at least one of Pr, Nd, La, Ce, or Y; RH includes at least one of Dy, Tb, Gd, or Ho; Fe is iron; B is boron; M includes Co, Cu, and M′, where M′ includes at least one of Cr, Ni, Ga, Al, Zr, Nb, or Ti; in the grain boundary phase A, an R content is in a range of 29 at % to 55 at %, a Co content is in a range of 3 at % to 7 at %, an Cu content is in a range of 7 at % to 20 at %; the diffusion depth of the heavy rare earth element RH in the NdFeB magnet is more than 500 μm.

The present disclosure reasonably designs the components of the substrate and the diffusion source, so that the R-containing grain boundary phases in the NdFEB magnet includes the grain boundary phase A, which is uniformly distributed along the grain boundaries, and can inhibit the abnormal growth of grains, preventing the degradation of magnetic performance of the NdFeB magnet due to abnormal grain growth; in addition, the enrichment of Co and Cu in the grain boundary phase reduces the eutectic temperature of the R-Fe system, which can effectively promote diffusion, effectively increase the diffusion depth, and realize that the diffusion depth of heavy rare earth elements in the NdFeB magnet can reach more than 500 μm. The magnet provided by the present disclosure has little reduction in remanence, and has high coercivity and high squareness.

In the present disclosure, the diffusion depth refers to that heavy rare earth elements RH are distributed in the grain boundary phase region more than 500 μm away from the surface of the NdFeB magnet.

In a specific embodiment of the disclosure, M includes Ga, and the content of Ga in the grain boundary phase A is in the range from 2 at % to 11 at %.

In a specific embodiment of the disclosure, the impurities include at least one of C, N, or O; the content of impurity elements in the NdFEB magnet is less than 1500 ppm; the content of N is less than 200 ppm. The NdFeB magnet provided by the present disclosure has low content of impurity elements, and R elements are difficult to combine with impurity elements respectively, which effectively avoids the formation of secondary phases other than main phase grains, and helps to improve the diffusion depth of heavy rare earth elements (e.g., Dy, Tb).

In a specific embodiment of the disclosure, an R content in the magnet is in a range of 28.5 wt % to 31 wt %, an M content in the magnet is in a range of 0.8 wt % to 3 wt %, a B content in the magnet is in a range of 0.94 wt % to 1.02 wt %, and the balance is iron and unavoidable impurities.

In a specific embodiment of the disclosure, a Co content in the magnet is in a range of 1 wt % to 1.5 wt %, a Cu content in the magnet is in a range of 0.15 wt % to 0.3 wt %, a Ga content in the magnet is in a range of 0.2 wt % to 0.4 wt %, a Ti and/or Zr content in the magnet is in a range of 0.05 wt % to 0.35 wt %. In the above embodiment, when the NdFeB magnet contains Zr and Ti, the total content of Zr and Ti in the NdFeB magnet is in the range from 0.1 wt % to 0.35 wt %; when the NdFEB magnet does not contain Ti, the content of Zr in the NdFeB magnet is in the range from 0.05 wt % to 0.3 wt %; when the NdFeB magnet does not contain Zr, the content of Ti in the NdFeB magnet is in the range from 0.05 wt % to 0.3 wt %.

In a specific embodiment of the disclosure, the D50 particle size of the main phase grains is in the range from 2.5 μm to 4 μm. In the above embodiment, the NdFeB magnet prepared by the method provided by the present disclosure contains the grain boundary phase A, which can effectively inhibit the growth of the main phase grain size, and the average grain size is small, so that the magnet performance is significantly improved. In the present disclosure, the D50 particle size of the main phase grains refers to the average of the equivalent circle diameters calculated from the cross-sectional areas of the main phase grains.

A second aspect of the present disclosure provides a method for preparing an NdFeB magnet, where the method comprises:
attaching a diffusion source to the surface of an NdFeB substrate to form a film layer;
performing a first diffusion treatment and a second diffusion treatment on the NdFeB substrate with the surface-attached film layer to obtain a diffusion-treated magnet; and
performing an aging treatment on the diffusion-treated magnet to obtain an NdFeB magnet;
where the NdFeB substrate includes R1, M1, B, and Fe, R1 includes at least one of Dy, Tb, Pr, Nd, La, Ce, Y, Ho and Gd; M1 includes Co, Cu, and M′, where M′ includes at least one of Cr, Ni, Ga, Al, Zr, Nb, or Ti; in the NdFeB substrate, the content of R1 is in the range from 28.5 wt % to 31 wt %, the content of M1 is in the range from 0.6 wt % to 2.5 wt %, the content of B is in the range from 0.94 wt % to 1.02 wt %, the content of Co is in the range from 0.5 wt % to 2.5 wt %, and the balance is Fe and impurity elements, for example, the content of M1 can be 0.6 wt %, 0.8 wt %, 1 wt %, 1.2 wt %, 1.8 wt %, 2.0 wt %, or any value within the range composed of any two of them.

The impurity elements include at least one of C, O, or N; the content of impurity elements in the NdFeB substrate is less than 1500 ppm, and the content of N is less than 200 ppm.

The diffusion source includes RH1, M2, and R2, where RH1 includes at least one of Dy, Tb, and Ho, R2 includes at least one of Pr and Nd, M2 includes Co and M2′, where M2′ includes at least one of Ga, Al, or Cu; in the diffusion source, the content of RH1 is in the range from 30 wt % to 70 wt %, the content of M2 is in the range from 5 wt % to 30 wt %, the content of R2 is in the range from 20 wt % to 50 wt %, and the content of Co is in the range from 1 wt % to 15 wt %; for example, the content of Co can be 1 wt %, 5 wt %, 8 wt %, 10 wt %, 12 wt %, 15 wt %, or any value within the range composed of any two of them; for example, the content of R2 can be 20 wt %, 25 wt %, 30 wt %, 35 wt %, 40 wt %, 45 wt %, 50 wt %, or any value within the range composed of any two of them.

In a specific embodiment of the disclosure, the content of Pr in R2 is in the range from 20 wt % to 35 wt %.

The temperature of the second diffusion treatment is in the range from 840° C. to 880° C., and the holding time is in the range from 4 h to 20 h; the ratio of the temperature of the first diffusion treatment to the temperature of the second diffusion treatment is in the range from 1.01 to 1.08; the ratio of the holding time of the first diffusion treatment to the holding time of the second diffusion treatment is in the range from 0.1 to 0.3.

For example, the temperature of the second diffusion treatment can be 840° C., 845° C., 850° C., 860° C., 865° C., 870° C., 880° C., or any value within the range composed of any two of them; the holding time can be 4 h, 5h, 6 h, 7.5h, 8 h, 10h, 12 h, 15h, 18 h, 20h, or any value within the range composed of any two of them; the ratio of the temperature of the first diffusion treatment to the temperature of the second diffusion treatment can be 1.01, 1.02, 1.03, 1.04, 1.05, 1.06, 1.07, 1.08, or any value within the range composed of any two of them; the ratio of the holding time of the first diffusion treatment to the holding time of the second diffusion treatment can be 0.1, 0.15, 0.2, 0.25, 0.3, or any value within the range composed of any two of them.

The present disclosure uses an NdFeB substrate with low content of impurity elements, so that rare earth elements are difficult to combine with impurity elements respectively, effectively avoiding the formation of secondary phases other than main phase grains, ensuring that the substrate has unobstructed diffusion channels, and helping to improve the diffusion depth of heavy rare earth elements (e.g., Dy, Tb) in subsequent diffusion treatments. Meanwhile, the composition of the diffusion source is reasonably designed, and Co is introduced to be enriched with Cu during diffusion, reducing the eutectic temperature of the R-Fe system, which can effectively promote diffusion and increase the diffusion depth; in addition, the addition of R2, especially Pr, can effectively reduce the eutectic point/melting point, which not only ensures that the light rare earth elements (e.g., Pr, Nd) and low-melting-point elements contained in the diffusion source further optimize the grain boundary structure of the NdFeB substrate during diffusion, but also provides a concentration gradient for the diffusion of heavy rare earth elements, promotes the diffusion of heavy rare earth elements into the interior of the substrate, and increases the diffusion depth of heavy rare earths. The present disclosure adopts a segmented diffusion process to perform diffusion treatment on the substrate, where the first diffusion treatment uses high-temperature and short-time heat treatment, which can form a uniform heavy rare earth shell layer on the surface of the main phase grains, effectively preventing more heavy rare earth elements from remaining on the surface of the main phase, and effectively promoting the diffusion of heavy rare earth elements into the interior of the magnet; the second diffusion treatment uses low-temperature and long-time heat treatment, which can further promote the diffusion of heavy rare earth elements into the interior of the magnet, effectively control the diffusion rate, and further improve the uniformity of diffusion. The method provided by the present disclosure can effectively increase the diffusion depth of heavy rare earth elements with good diffusion effect, significantly improve the coercivity, and achieve high remanence and high squareness.

In the present disclosure, the way of attaching the diffusion source to the surface of the NdFeB substrate also includes at least one of vacuum physical vapor deposition, patch attachment, coating, electrophoresis, and screen printing; preferably, magnetron sputtering is used for attachment. The form of the diffusion source alloy can be target, sheet, strip, or powder.

In a specific embodiment of the disclosure, the diffusion source is attached to the surface of the NdFeB substrate by magnetron sputtering; in a further embodiment, the NdFeB substrate can be subjected to machining and pretreatment, and then magnetron sputtering is performed. Machining is performed to obtain slices with a thickness in the range from 1 mm to 10 mm along the magnetization direction, the coating surface of magnetron sputtering is the surface perpendicular to the magnetization direction, and the weight gain of the NdFeB substrate with the attached diffusion source film layer can be in the range from 0.5% to 1.5%. In the above embodiment, by selecting a diffusion process more matching the composition design of the diffusion source, the present disclosure can further improve the diffusion depth and diffusion effect of heavy rare earth elements, significantly improve the coercivity, and achieve high remanence and high squareness.

In a specific embodiment of the disclosure, in the NdFeB substrate, the content of R1 is in the range from 29.5 wt % to 30.5 wt %, the content of M1 is in the range from 0.6 wt % to 1.5 wt %, the content of B is in the range from 0.96 wt % to 1.0 wt %, and the balance is Fe and impurity elements; where, the content of Dy in the NdFeB substrate is in the range from 2 wt % to 4 wt %, preferably in the range from 2.5 wt % to 3.5 wt %.

In a specific embodiment of the disclosure, the content of Co is in the range from 1 wt % to 1.5 wt %.

In a specific embodiment of the disclosure, the content of Cu in the NdFeB substrate is in the range from 0.1 wt % to 0.3 wt %, preferably in the range from 0.15 wt % to 0.25 wt %.

In a specific embodiment of the disclosure, M1 further includes Ga, and the content of Ga is in the range from 0.1 wt % to 0.5 wt %, preferably in the range from 0.25 wt % to 0.35 wt %.

In a specific embodiment of the disclosure, M1 further includes Zr and/or Ti, and the content of Zr and/or Ti is in the range from 0.05 wt % to 0.35 wt %.

In a specific embodiment of the disclosure, the first diffusion treatment and the second diffusion treatment is repeated to obtain the diffusion-treated magnet; optionally, the total number of times that the first diffusion treatment and the second diffusion treatment are performed is in the range from 2 to 8. In the above embodiment, the present disclosure repeats the above segmented diffusion process multiple times, aiming to further improve the diffusion of heavy rare earth elements into the center of the magnet and the uniformity of diffusion for the components of the substrate and diffusion source provided by the present disclosure, and can effectively control the size of main phase grains, thereby improving the coercivity of the magnet.

In a specific embodiment of the disclosure, the method further comprises: sequentially performing a molding process and a sintering process on NdFeB raw material alloy powder to obtain the NdFeB substrate.

In a specific embodiment of the disclosure, the molding process is an oriented pressing molding process, which is performed under an oriented magnetic induction intensity in the range from 1.8 T to 2.3 T.

In a specific embodiment of the disclosure, the sintering treatment includes a first sintering treatment and a second sintering treatment; the temperature of the first sintering treatment is in the range from 750° C. to 980° C., and the sintering time is in the range from 8 h to 10 h; the temperature of the second sintering treatment is in the range from 1000° C. to 1080° C., and the sintering time is in the range from 8 h to 12 h; the vacuum degree of the sintering treatment is in the range from 10⁻⁵ Pa to 10⁻² Pa; the density of the NdFeB substrate obtained by the sintering treatment is in the range from 7.5 g/cm³ to 7.8 g/cm³. In the above embodiment, the adoption of the above staged sintering treatment can effectively avoid the abnormal growth of main phase grain size, and at the same time effectively control the content of impurity elements in the magnet, provide a better grain boundary structure, and provide better diffusion channels for subsequent diffusion treatments.

In a specific embodiment of the disclosure, the method further comprises: performing machining and pretreatment on the NdFeB substrate; the machining includes: slicing the NdFeB substrate perpendicular to the magnetization direction to obtain NdFeB magnetic sheets, where the thickness along the magnetization direction is in the range from 1 mm to 10 mm; the pretreatment includes: sequentially performing oil removal, ultrasonic cleaning, and drying on the NdFeB magnetic sheets, where the drying temperature is in the range from 20° C. to 80° C.

In a specific embodiment of the disclosure, the temperature of aging treatment is in a range from 450° C. to 690° C., the holding time is range from 0.5h to 4h.

In a specific embodiment of the disclosure, the method further comprises: after the aging treatment, cooling the NdFeB magnet to below 400° C. at a cooling rate in the range from 6° C./min to 30° C./min, preferably in the range from 8° C./min to 20° C./min. In the above embodiment, rapid cooling after aging treatment can effectively inhibit the segregation of ferromagnetic phases in the grain boundary phase, and further improve the coercivity of the magnet.

In a specific embodiment of the disclosure, the method further comprises: preparing NdFeB raw material alloy flakes by a rapid solidification process, and performing hydrogen decrepitation and jet milling on the NdFEB raw material alloy flakes to obtain the NdFeB raw material alloy powder; the D50 particle size of the NdFeB raw material alloy powder is in the range from 2 μm to 5 μm.

A third aspect of the present disclosure provides an NdFeB magnet prepared by the method described in the second aspect of the present disclosure.

In a specific embodiment, the remanence of the NdFeB magnet is greater than 13.6 kGs, the coercivity is greater than 29.5 kOe, and the squareness is greater than 0.96.

The present disclosure is further illustrated below with reference to examples, but the present disclosure is not limited thereby in any way. The raw materials used in the embodiments and comparative embodiments are all available through commercial purchase channels.

The present disclosure will be further illustrated by the following examples, but the present disclosure is not limited thereby. The raw materials used in the examples and comparative examples can be obtained through commercial channels.

### Embodiment 1

### Preparing the NdFeB Magnet by the Following Steps:

Preparing NdFeB raw material alloy flakes by a rapid solidification process; performing hydrogen decrepitation and jet milling on the NdFeB raw material alloy flakes to obtain the NdFeB raw material alloy powder with D50 particle size of 2.5 μm; the raw material alloy powder is pressed and formed at normal temperature and in an orientation field with a magnetic field strength of 2 T; the formed green compact is placed into a vacuum sintering furnace for sintering treatment to obtain NdFeB substrate, the vacuum degree of the vacuum sintering furnace is 10⁻³ Pa, the temperature of the first sintering treatment is 850° C., the holding time is 8 h, the temperature of the second sintering treatment is 1058° C., and the holding time is 10 h.

The NdFeB substrate includes R1, M1, B, and Fe; where R1 includes PrNd and Dy, and M1 includes Co, Cu, Ga, Zr, and Ti. In the NdFeB substrate, the content of PrNd is 26.7 wt %, the content of Dy is 3.1 wt %, the content of Co is 1.1 wt %, the content of Cu is 0.2 wt %, the content of Ga is 0.25 wt %, the content of Zr is 0.05 wt %, the content of Ti is 0.05 wt %, and the content of B is 0.99 wt %; the balance is Fe and impurity elements. The impurity elements include C, O, and N; among the impurity elements, the total content of C and O is from 1150 ppm to 1300 ppm, and the content of N is from 180 ppm to 190 ppm. The magnet density of the NdFeB substrate after sintering is 7.8 g/cm³.

Machining the NdFeB substrate into NdFEB magnetic sheets with dimensions of 4 mm (orientation direction)×10 mm×10 mm, sequentially performing oil removal, ultrasonic cleaning, and drying on the magnetic sheets, with a drying temperature of 70° C.; performing magnetron sputtering on the surface of the machined NdFeB magnetic sheets perpendicular to the magnetization direction using a diffusion source to obtain an NdFeB substrate with a surface-attached film layer; the weight gain of the surface-attached film layer after magnetron sputtering treatment being 1.0%;

The diffusion source includes RH1, M2, and R2; the RH1 includes Dy; the R2 includes PrNd; the M2 includes Co, Cu, Ga, and Al; in the diffusion source, the content of Dy is 55 wt %, the content of Co is 5 wt %, the content of Cu is 5 wt %, the content of Ga is 5 wt %, the content of Al is 5 wt %, and the content of PrNd is 25 wt %.

Performing a first diffusion treatment and a second diffusion treatment on the NdFeB substrate with the surface-attached film layer; the temperature of the first diffusion treatment is 905° C., the holding time is 1 h, the temperature of the second diffusion treatment is 870° C., the holding time is 5 h; the ratio of the temperature of the first diffusion treatment to the temperature of the second diffusion treatment is 1.04; the ratio of the holding time of the first diffusion treatment to the holding time of the second diffusion treatment is 0.2.

Repeating above the first diffusion treatment and the second diffusion treatment to obtain a diffusion-treated magnet; the number of repetitions being 3.

Performing aging treatment on the diffusion-treated magnet at a temperature of 520° C. for a holding time of 3 h, and then cooling it at a cooling rate of 15° C./min after aging to obtain NdFeB magnet 1, denoted as CT-1. Through elemental analysis, the content of impurity elements (including C, N, and O) in NdFeB magnet CT-1 is less than 1500 ppm, where the content of N is less than 200 ppm, and R in the grain boundary phase A including Dy, Pr, and Nd.

### Embodiment 2

Referring to the preparation method in Embodiment 1, the difference in Embodiment 2 lies in the temperature of the first diffusion treatment is 890° C., the temperature of the second diffusion treatment is 880° C., and the ratio of the temperature of the first diffusion treatment to the temperature of the second diffusion treatment is 1.01, to obtain NdFeB magnet 2, denoted as CT-2.

### Embodiment 3

Referring to the preparation method in Embodiment 1, the difference in Embodiment 3 lies in the content of Co in the NdFeB substrate is 0.6 wt %, to obtain NdFeB magnet 3, denoted as CT-3.

### Embodiment 4

Referring to the preparation method in Embodiment 1, the difference in Embodiment 4 lies in the content of Co in the diffusion source is 2 wt %, to obtain NdFeB magnet 4, denoted as CT-4.

### Embodiment 5

Referring to the preparation method in Embodiment 1, the difference in Embodiment 5 lies in the content of Co in the diffusion source is 13 wt %, to obtain NdFeB magnet 5, denoted as CT-5.

### Comparative Embodiment 1

Referring to the preparation method in Embodiment 1, the difference in Comparative Embodiment 1 lies in that the diffusion source does not contain Co; to obtain NdFeB magnet, denoted as DCT-1.

### Comparative Embodiment 2

Referring to the preparation method in Embodiment 1, the difference in Comparative Embodiment 2 lies in that multi-stage diffusion process is not adopted, and the diffusion treatment is carried out at a temperature of 870° C. for a holding time of 18 h; to obtain NdFeB magnet, denoted as DCT-2.

### Comparative Embodiment 3

Referring to the preparation method in Embodiment 1, the difference in Comparative Embodiment 3 lies in the content of N in the impurity elements is in the range from 450 ppm to 550 ppm, to obtain NdFeB magnet, denoted as DCT-3

### Test Embodiment

The average particle size D50 of the raw material alloy powder is measured using a particle size analyzer.

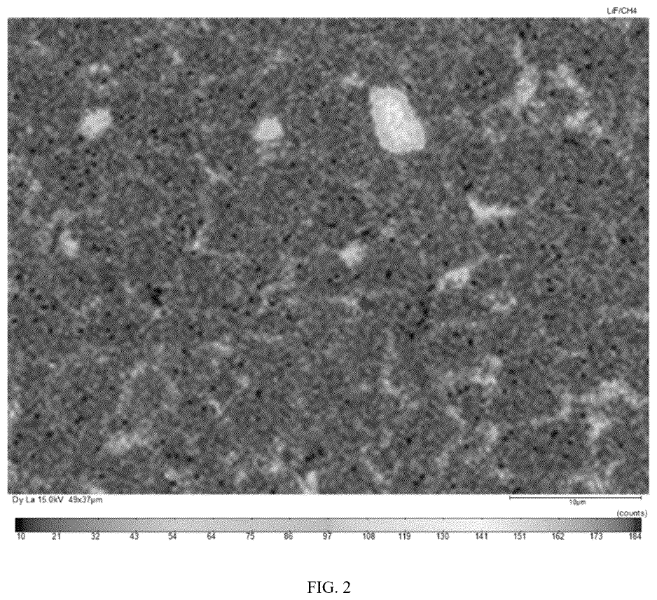

The NdFeB magnet prepared in Embodiment 1 is subjected to scanning test using EPMA. The EPMA test result at a depth of 500 μm is shown in FIG. 2, where the heavy rare earth elements can be distinguished according to the electron backscatter images, with the gray substrate representing the distribution of Dy element and the black substrate representing the main phase grains.

The microstructure of the NdFeB magnet prepared in Embodiment 1 is tested using SEM, obtaining the SEM microstructure image.

The atomic percentages of each element in the grain boundary phase of the neodymium-iron-boron magnets of Embodiments 1-5 and Comparative Examples 1-3 are tested using EDS energy spectrum analysis, and the results are shown in Table 1.

The magnetic properties of the NdFeB magnets of Embodiments 1-5 and Comparative Examples 1-3 are tested using a B-H tracer, and the results are listed in Table 2.

TABLE 1

| | | | | | Whether Grain |
|---|---|---|---|---|---|
| NdFeB | Grain Boundary Phase A | | | | Boundary Phase |
| Magnet | R/at % | Co/at % | Cu/at % | Ga/at % | A Exists |
| CT-1 | 45.7 | 5.1 | 10.2 | 4.8 | YES |
| CT-2 | 46.3 | 4.9 | 10.8 | 3.9 | YES |
| CT-3 | 40.1 | 4.1 | 10.1 | 3.5 | YES |
| CT-4 | 42.2 | 3.87 | 9.05 | 7.5 | YES |
| CT-5 | 45.8 | 5.8 | 15.4 | 4.6 | YES |
| DCT-1 | — | — | — | — | NO |
| DCT-2 | — | — | — | — | NO |
| DCT-3 | 28.6 | 3.4 | 7.3 | 2.9 | YES |

TABLE 2

| NdFeB Magnet | Br (kGs) | HcJ (kOe) | Hk/HcJ |
|---|---|---|---|
| CT-1 | 13.71 | 30.5 | 0.98 |
| CT-2 | 13.73 | 30.1 | 0.97 |
| CT-3 | 13.75 | 29.8 | 0.97 |
| CT-4 | 13.74 | 29.9 | 0.98 |
| CT-5 | 13.72 | 29.7 | 0.98 |
| DCT-1 | 13.75 | 29.3 | 0.97 |
| DCT-2 | 13.73 | 29.6 | 0.97 |
| DCT-3 | 13.68 | 28.8 | 0.95 |

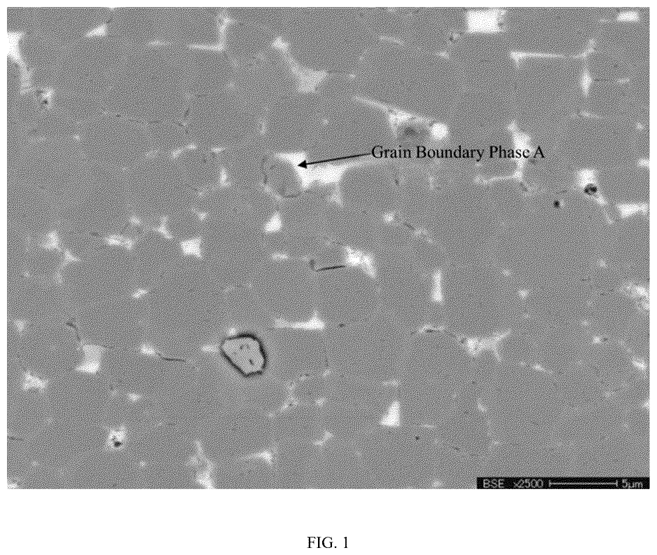

It can be seen from Tables 1 and 2 that the method provided by the present disclosure controls the content of impurity elements (C, N, O) to be low by regulating the composition of the NdFeB substrate, and at the same time, reasonably designs the composition of the diffusion source to control the contents of R2, Co, and M2 within the ranges defined in the present disclosure, which can effectively promote the diffusion of heavy rare earth elements, increase the diffusion depth to more than 500 μm, and at the same time promote more Co elements to penetrate into the grain boundary phase. As shown in FIG. 1, a grain boundary phase A rich in Co and Cu can be formed in the grain boundary phase, so that Co and Cu elements are enriched in the grain boundary phase, reducing the influence of the reverse shell layer on the diffusion depth of heavy rare earth elements during diffusion, so that the coercivity of the prepared NdFeB magnet is significantly improved, with high remanence and high squareness.

Comparing Embodiments 3, 4, and 5 with Embodiment 1, it can be seen that controlling the content of Co in the NdFeB substrate and the content of Co in the diffusion source within the ranges defined in the present disclosure can effectively promote the diffusion of Co elements into the interior of the magnet, promote the enrichment of Co and Cu in the grain boundary phase, and the coercivity of the prepared NdFeB magnet is more significantly improved, reaching 30.5 kOe.

Comparing Comparative Embodiment 1 with Embodiment 1, it can be seen that since the diffusion source in Comparative Embodiment 1 does not contain Co, it is impossible to form a grain boundary phase A rich in Co and Cu in the grain boundary phase, so that the reverse shell layer hinders the diffusion depth of heavy rare earth elements during diffusion, significantly reducing the diffusion depth and diffusion effect, thus resulting in the coercivity of the NdFeB magnet provided in Comparative Embodiment 1 being lower than that in the embodiments of the present disclosure.

Comparing Comparative Embodiment 2 with Embodiment 1, it can be seen that since Comparative Embodiment 2 does not adopt a multi-stage diffusion process, it is impossible to form a uniform heavy rare earth shell layer on the surface of the main phase grains, so that more heavy rare earth elements remain on the surface of the main phase, and heavy rare earth elements and Co elements cannot diffuse well into the interior of the magnet; at the same time, the size of main phase grains cannot be effectively controlled, thus reducing the coercivity of the magnet provided in Comparative Embodiment 2.

Comparing Comparative Embodiment 3 with Embodiment 1, it can be seen that since the content of impurity element N in the NdFeB substrate used in Comparative Embodiment 3 is not within the range defined in the present disclosure, R elements combine with impurity elements excessively, promoting the formation of secondary phases other than main phase grains, which easily leads to blockage of the diffusion channels of the substrate, thus reducing the diffusion depth of heavy rare earth elements in subsequent diffusion treatments, and further reducing the remanence, coercivity, and squareness of the magnet provided in Comparative Embodiment 3.

The above describes the preferred embodiments of the present disclosure in detail with reference to the accompanying drawings, but the present disclosure is not limited to the specific details in the above embodiments. Within the technical concept of the present disclosure, various simple modifications can be made to the technical solution of the present disclosure, and these simple modifications all belong to the protection scope of the present disclosure.

In addition, it should be noted that the various specific technical features described in the above specific embodiments can be combined in any suitable way without unnecessary repetition, and the present disclosure will not separately describe various possible combinations.

In addition, various different embodiments of the present disclosure can also be combined arbitrarily, as long as they do not violate the idea of the present disclosure, they should also be regarded as the disclosed content of the present disclosure.

1. A high-coercivity and high-remanence NdFeB magnet comprising R, M, B, and Fe, wherein:
R includes RL and RH, RL includes at least one of Pr, Nd, La, Ce, or Y, and RH includes at least one of Dy, Tb, Gd, or Ho;
M includes Co, Cu, and M′, and M′ includes at least one of Cr, Ni, Ga, Al, Zr, Nb, or Ti;
the NdFeb magnet includes R2 T₁₄B main phase grains and grain boundary phase;
R content in the grain boundary phase is in a range of 29 at % to 55 at %, Co content in the grain boundary phase is in a range of 3 at % to 7 at %, Cu content in the grain boundary phase is in a range of 7 at % to 20 at %; and
diffusion depth of RH in the NdFeB magnet is more than 500 μm.

2. The NdFeB magnet according to claim 1, wherein M includes Ga, and Ga content in the grain boundary phase is in a range of 2 at % to 11 at %.

3. The NdFeB magnet according to claim 1, wherein impurities in the NdFeB magnet include at least one of C, N, or O, content of the impurities in the NdFeB magnet is less than 1500 ppm, and content of N in the NdFeB magnet is less than 200 ppm.

4. The NdFeB magnet according to claim 1, wherein:
R content in the NdFeB magnet is in a range of 28.5 wt % to 31 wt %, M content in the magnet is in a range of 0.8 wt % to 3 wt %, and B content in the magnet is in a range of 0.94 wt % to 1.02 wt %;
Co content in the magnet is in a range of 1 wt % to 1.5 wt %, Cu content in the magnet is in a range of 0.15 wt % to 0.3 wt %, Ga content in the magnet is in a range of 0.2 wt % to 0.4 wt %, and Ti and/or Zr content in the magnet is in a range of 0.05 wt % to 0.35 wt %; and
D50 particle size of the main phase grains is in a range from 2.5 μm to 4 μm.

5. A method for preparing the NdFeB magnet according to claim 1, comprising:
attaching a diffusion source to a surface of an NdFeB substrate to form a film layer;
performing a first diffusion treatment and a second diffusion treatment on the NdFeB substrate with the surface-attached film layer to obtain a diffusion-treated magnet; and
performing an aging treatment on the diffusion-treated magnet to obtain the NdFeB magnet;
wherein:
the second diffusion treatment is performed with a temperature in a range from 840° C. to 880° C. and a holding time in a range from 4 h to 20 h;
a ratio of a temperature of the first diffusion treatment to the temperature of the second diffusion treatment is in a range from 1.01 to 1.08; and
a ratio of a holding time of the first diffusion treatment to the holding time of the second diffusion treatment is in a range from 0.1 to 0.3.

6. The method according to claim 5, wherein:
the NdFeB substrate includes R1, M1, B, and Fe;
R1 includes at least one of Dy, Tb, Pr, Nd, La, Ce, Y, Ho, or Gd;
M1 includes Co, Cu, and M′;
R1 content in the NdFeB substrate is in a range from 28.5 wt % to 31 wt %, M1 content in the NdFeB substrate is in a range from 0.6 wt % to 2.5 wt %, B content in the NdFeB substrate is in a range from 0.94 wt % to 1.02 wt %, and Co content in the NdFeB substrate is in a range from 0.5 wt % to 2.5 wt %; and
impurities in the NdFeB substrate include at least one of C, N, or O, content of the impurities in the NdFeB magnet is less than 1500 ppm, and N content in the NdFeB magnet is less than 200 ppm.

7. The method according to claim 6, wherein:
R1 content in the NdFeB substrate is in a range from 29.5 wt % to 30.5 wt %, M1 content in the NdFeB substrate is in a range from 0.6 wt % to 1.5 wt %, B content in the NdFeB substrate is in a range from 0.96 wt % to 1.0 wt %, and Co content in the NdFeB substrate is in the range from 1 wt % to 1.5 wt %;
Dy content in NdFeB substrate is in a range from 2 wt % to 4 wt %;
Co content in the magnet is in a range of 1 wt % to 1.5 wt %, Cu content in the magnet is in a range of 0.1 wt % to 0.3 wt %, Ga content in the magnet is in a range of 0.1 wt % to 0.5 wt %, and Ti and/or Zr content in the magnet is in a range of 0.05 wt % to 0.35 wt %.

8. The method according to claim 5, further comprising:
performing molding process on NdFeB alloy powder and then sintering treatment to obtain the NdFeB substrate;
wherein:
D50 particle size of the NdFeB alloy powder is in a range from 2 μm to 5 μm;
the molding process is an oriented pressing molding process, magnetic field strength of the oriented pressing molding process is in a range from 1.8 T to 2.3 T;
the sintering treatment includes a first sintering treatment and a second sintering treatment;
the first sintering treatment is performed with a temperature in a range from 750° C. to 980° C. and a sintering time in a range from 8 h to 10 h;
the second sintering treatment is performed with a temperature in a range from 1000° C. to 1080° C. and a sintering time in a range from 8 h to 12 h;
vacuum degree of the sintering treatment is in a range from 10⁻⁵ Pa to 10⁻² Pa;
density of the NdFeB substrate obtained by the sintering treatment is in a range from 7.5 g/cm³ to 7.8 g/cm³; and
the aging treatment is performed with a temperature in a range from 450° C. to 690° C. and a holding time in a range from 0.5h to 4h.

9. The method according to claim 5, wherein:
the diffusion source includes RH1, M2, and R2;
RH1 includes at least one of Dy, Tb, or Ho;
R2 includes at least one of Pr or Nd;
M2 includes Co and M2′, M2′ includes at least one of Ga, Al, or Cu; and
RH1 content in the diffusion source is in a range from 30 wt % to 70 wt %, M2 content in the diffusion source is in a range from 5 wt % to 30 wt %, R2 content in the diffusion source is in a range from 20 wt % to 50 wt %, and Co content in the diffusion source is in a range from 1 wt % to 15 wt %.

10. The method according to claim 9, wherein
the RH1 content in the diffusion source is in a range from 45 wt % to 65 wt %, the M2 content in the diffusion source is in a range from 10 wt % to 20 wt %, the R2 content in the diffusion source is in a range from 30 wt % to 40 wt %, and the Co content in the diffusion source is in a range from 5 wt % to 10 wt %.
